(19) United States
(12) Patent Application Publication
(10) Pub. No.: US 2017/0351079 A1
(43) Pub. Date: Dec. 7, 2017

(54) SURGICAL MICROSCOPE SYSTEM

(71) Applicant: MITAKA KOHKI CO., LTD., Tokyo (JP)

(72) Inventor: Katsuyuki NAKAMURA, Tokyo (JP)

(73) Assignee: MITAKA KOHKI CO., LTD., Tokyo (JP)

(21) Appl. No.: 15/603,852

(22) Filed: May 24, 2017

(30) Foreign Application Priority Data
Jun. 7, 2016 (JP) 2016-113204

(51) Int. Cl. G02B 21/22; G02B 21/02; G02B 21/00; G02B 21/36; H04N 13/04; H04N 13/02

(52) U.S. Cl. CPC G02B 21/22; H04N 13/0429; H04N 13/0239; G02B 21/0012; G02B 21/361; G02B 21/025; G02B 21/368

(57) ABSTRACT

A surgical microscope system includes a surgical microscope. In the surgical microscope, variable power optical systems are arranged horizontally to fold optical paths, thereby reducing a vertical size between eyepieces of the surgical microscope and a lower end of the same and expanding a working space under the surgical microscope. A camera is attached to an upper part of the surgical microscope to free a side face of the surgical microscope so that an accessory such as a fluorescent camera is attached to the side face.

### BACKGROUND OF THE INVENTION

### 1. Field of the Invention

The present invention relates to a surgical microscope system having a camera capable of stereoscopically photographing images of a surgical field.

### 2. Description of Related Art

A surgical microscope according to a related art has an objective optical system and a pair of variable power optical systems that are arranged vertically above the objective optical system. Light travels from a surgical field through the objective optical system to the variable power optical systems, which output optical beams into eyepieces arranged above the variable power optical systems, respectively. Through the eyepieces, a surgeon observes an optical image of the surgical field with his or her eyes. The surgical microscope may be provided with a camera to take electronic images of the surgical field. The electronic images are displayed on an electronic image display unit for an assistant of the surgeon to observe the surgical field.

To guide light from the surgical field to the camera, an optical branching unit is arranged in front of the variable power optical systems. The optical branching unit branches the light travelling from the surgical field into a horizontal thick beam of light, which is reflected upward and is introduced into the camera that is attached in an upright state to a left or right side face of the surgical microscope. The camera incorporates a pair of variable power optical systems and a pair of imaging elements. The camera is rotatable around an optical axis of the upwardly reflected thick beam. Out of this thick beam, the variable power optical systems of the camera pick up a pair of thin beams of light according to a rotation position or orientation of the camera. The thin beams are guided to the imaging elements, which provide electronic images of the surgical field, the electronic images having an orientation based on the rotation position of the camera and possessing binocular parallax. The electronic images are displayed on the electronic image display unit so that the assistant may observe them. The related art is disclosed in, for example, Japanese Unexamined Patent Application Publication No. 2014-170084 (Patent Literature 1).

The related art arranges the objective optical system and variable power optical systems one above the other in a vertical (up-down) direction to elongate a vertical dimension of the surgical microscope, or narrow a distance to a working space between a lower end of the surgical microscope and the surgical field. The eyes of the surgeon are positioned on the eyepieces at an upper end of the surgical microscope. In this posture, the surgeon has a limited downward extending range for his or her hands. Namely, the longer the vertical dimension of the surgical microscope, the narrower the working space under the microscope is limited.

In addition, the related art installs the camera on one of the right and left side faces of the surgical microscope. The other side face of the microscope is usually fixed to an arm of a stand apparatus that supports the surgical microscope. Namely, both the side faces of the surgical microscope are occupied with these items and have no space to attach another item thereto.

### SUMMARY OF THE INVENTION

In consideration of the problems of the related art, the present invention provides a surgical microscope system capable of expanding a working space under a surgical microscope and allowing an accessory to be attached to a side face of the surgical microscope.

According to a first aspect of the present invention, the surgical microscope system includes a surgical microscope, a camera, and an electronic image display unit. The surgical microscope includes a vertically-oriented objective optical system to pass a vertical beam of light from a surgical field that is an observation object and an optical branching unit to branch the vertical beam into a horizontal backward first beam of light and a vertical upward second beam light. The surgical microscope also includes a pair of horizontally-oriented variable power optical systems, an upper-and-lower pair of first reflectors, and a left-and-right pair of eyepieces, optical paths passing through these units being defined such that two horizontal beams of light derived from the first beam are guided through the variable power optical systems, respectively, are reflected by the first reflectors in a frontward direction above the variable power optical systems, and are introduced into the eyepieces. The eyepieces allow the surgical field to be optically observed. The surgical microscope further includes a second reflector that provides a horizontal second beam by reflecting the second beam in a horizontal direction and an optical outlet that is arranged at an upper part of the surgical microscope and outputs the horizontal second beam. The camera is attached to the optical outlet so that the camera is rotatable around an optical axis of the horizontal second beam. The camera includes a pair of variable power optical systems and a pair of imaging elements, to pick up a pair of beams out of the horizontal second beam according to a rotation position of the camera, pass the picked-up beams through the variable power optical systems to the imaging elements, respectively, and provide from the imaging elements electronic images having binocular parallax and an orientation based on the rotation position of the camera. The electronic image display unit displays the electronic images provided by the camera.

According to a second aspect of the present invention, the camera is attachable to and detachable from the optical outlet.

According to a third aspect of the present invention, the camera includes a reflector to reflect the picked-up beams by 90 degrees in opposite directions, the imaging elements being arranged orthogonal to the oppositely reflected beams, respectively.

According to a fourth aspect of the present invention, the electronic image display unit is a 3D viewer incorporating a left-and-right pair of display panels to display the electronic images provided by the camera and a pair of eyepieces to enable the displayed images to be observed with the eyes of an observer.

### BRIEF DESCRIPTION OF THE DRAWINGS

FIG. 1 is a perspective view illustrating a surgical microscope and 3D viewer included in a surgical microscope system according to an embodiment of the present invention;

FIG. 2 is a sectional view illustrating the surgical microscope and a camera to be attached to the microscope;

FIG. 3 is a sectional view illustrating the surgical microscope and the camera attached thereto;

FIG. 4 is a sectional view illustrating the surgical microscope and the camera that is turned by 90 degrees from FIG. 3;

FIG. 5 is a perspective view illustrating internal structures of the surgical microscope and camera;

FIG. 6 is a perspective view illustrating the internal structures of the surgical microscope and camera, the camera being turned by 90 degrees from FIG. 5; and

FIG. 7 is a front view illustrating the camera seen in the direction of an arrow mark DA of FIG. 6.

### DESCRIPTION OF PREFERRED EMBODIMENTS

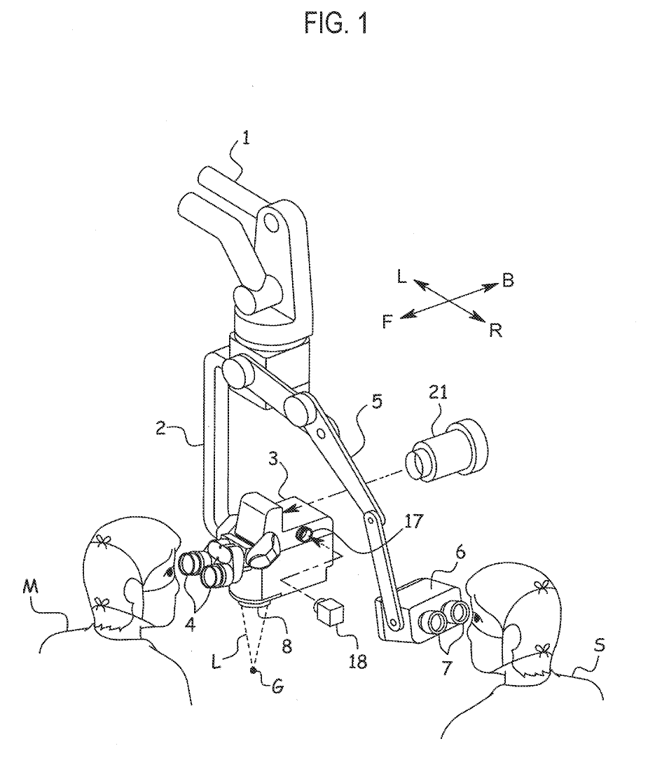

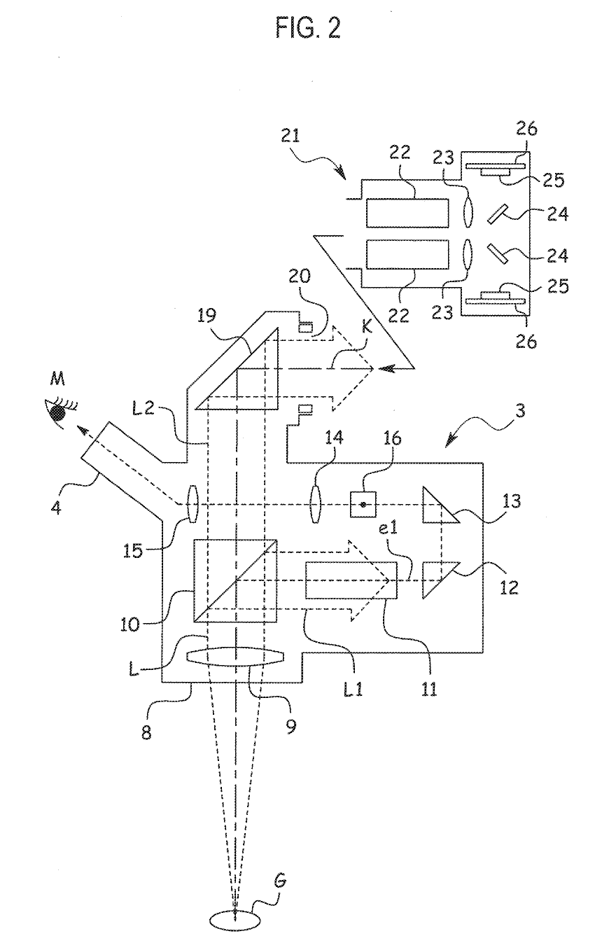

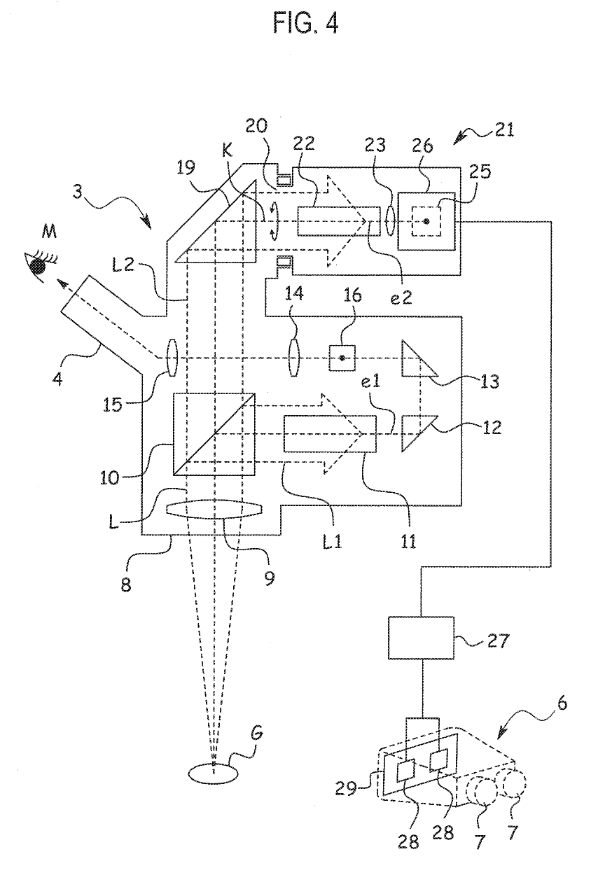

A surgical microscope system according to an embodiment of the present invention will be explained with reference to FIGS. 1 to 7. Through the drawings and explanation, directions front (F), back (B), left (L), and right (R) are as illustrated in FIG. 1. Namely, the front F is on the eyepiece side of a surgical microscope 3, the back B is opposite to the front F, the left L is left when facing eyepieces 4 of the microscope 3, and the right R is opposite to the left L.

In an operating room, the surgical microscope system is installed on a stand apparatus (not illustrated). The stand apparatus has a support arm 1 and a suspension arm 2 extending downward from a front end of the support arm 1. A lower end of the suspension arm 2 supports a left side face of the surgical microscope 3 of the surgical microscope system. A front side face of the surgical microscope 3 has the eyepieces 4. Through the eyepieces 4, a doctor M optically observes a surgical field G and conducts an operation on the surgical field G.

A secondary arm 5 is extended from the front end of the support arm 1. A front end of the secondary arm 5 supports an electronic image display unit or a 3D viewer 6. The 3D viewer 6 is positioned in the vicinity of the right side of the surgical microscope 3, to enable an assistant S standing on the right side of the surgical microscope 3 to use the 3D viewer 6. The 3D viewer 6 has eyepieces 7 through which the assistant S stereoscopically observes an electronic image of the surgical field G and assists the doctor M with the operation.

An internal structure of the surgical microscope 3 will be explained.

The surgical microscope 3 is configured to enable a stereoscopic observation. A thick beam of light L traveling from the surgical field G as an observation object is introduced into an optical inlet 8 that is formed at a lower end of the surgical microscope 3. Arranged above the optical inlet 8 is an objective optical system 9 including lenses arranged in a vertical (perpendicular) direction. Arranged above the objective optical system 9 is a beam splitter 10 serving as an optical branching unit.

The beam of light L passing through the objective optical system 9 is branched by the beam splitter 10 into a horizontal first beam of light L1 directed backward and a vertical second beam of light L2 directed upward.

Arranged behind the beam splitter 10 are a left-and-right pair of variable power optical systems 11 including lenses. From among components of the first beam of light L1, a left-and-right pair of beams of light e1 pass through the variable power optical systems 11, respectively. Behind the variable power optical systems 11, prisms 12 and 13 are arranged in a vertical direction. The beams of light e1 passing through the variable power optical systems 11 are reflected upward by the prisms 12, and then above the variable power optical systems 11, frontward by the prisms 13. Thereafter, the beams of light e1 pass through image forming lenses 14 to the eyepieces 4 that include eyepiece lenses 15. Through the eyepieces 4, the doctor M is able to stereoscopically observe an image of the surgical field G. An optical axis of each of the beams of light e1 derived from the first beam of light L1 crosses an optical axis of the second beam of light L2. Namely, optical paths of the beams of light L1 (e1) and L2 are folded relative to each other within the surgical microscope 3, and therefore, optical elements in the surgical microscope 3 are densely arranged along the folded optical paths, to make the surgical microscope 3 compact.

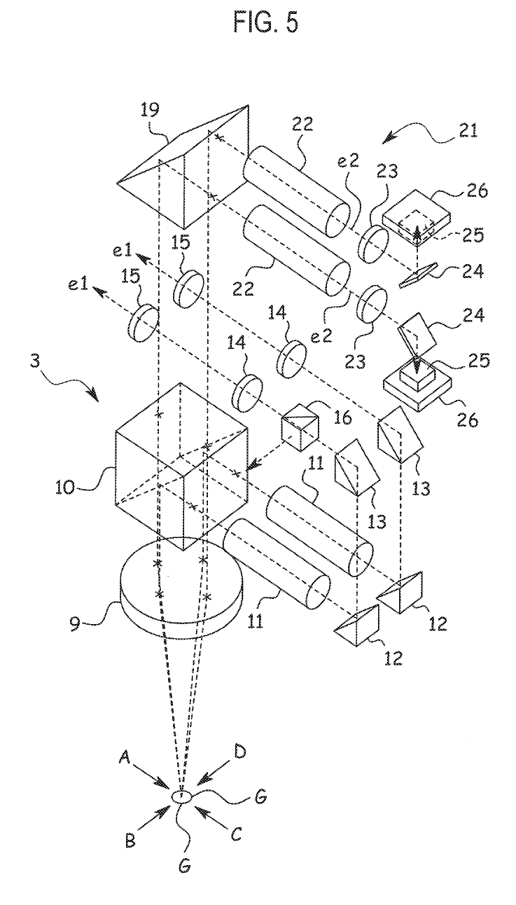

In the optical path of one (right one in FIG. 5) of the two beams of light e1 over the variable power optical systems 11, a beam splitter 16 is arranged to output part of the beam of light e1 to an accessory connection port 17 (FIG. 1). To the accessory connection port 17, an accessory such as a fluorescent camera 18 is attached to photograph light of specific wavelengths.

In this way, the surgical microscope 3 is configured such that the variable power optical systems 11 are horizontal and the beams of light e1 are folded by reflection, and therefore, a vertical dimension H between the upper eyepieces 4 and the lower optical inlet 8 of the surgical microscope 3 is small to expand a working space WD between the optical inlet 8 and the surgical field G.

The second beam of light L2 traveling upward from the beam splitter 10 is reflected by a prism 19 in a horizontal direction toward an optical outlet 20 at an upper part of the surgical microscope 3. When not used, the optical outlet 20 is covered with a cap (not illustrated).

A camera 21 is attachable to the optical outlet 20. The camera 21 incorporates a pair of variable power optical systems 22 including lenses and a pair of image forming lenses 23. Arranged behind the image forming lenses 23 are reflectors, i.e., mirrors 24 that change optical axes by 90 degrees, respectively, into opposite directions. Arranged on an outer side of each mirror 24 is an imaging element 25 such as a CCD image sensor in which an imaging area thereof faces orthogonal to a primary axis of the variable power optical system 22 due to the mirrors 24. Each imaging element 25 is attached to a large substrate 26. If the imaging elements 25 are arranged just behind the variable power optical systems 22, the substrates 26 attached to the imaging elements 25 will interfere with each other. To avoid this, the imaging elements 25 are opposed to each other and are outwardly spaced away from each other.

As mentioned above, the variable power optical systems 11 for the first beam of light L1 and the variable power systems 22 for the second beam of light L2 are horizontally arranged, to reduce the vertical dimension of the surgical microscope 3. An optical axis of each beam of light e1 derived from the first beam of light L1 crosses an optical axis of the second beam of light L2, to make the surgical microscope 3 structurally simple. This configuration allows the variable power optical systems 22 to be arranged over the variable power optical systems 11, thereby reducing up-down and left-right dimensions of the surgical microscope 3 and realizing compactness of the surgical microscope 3.

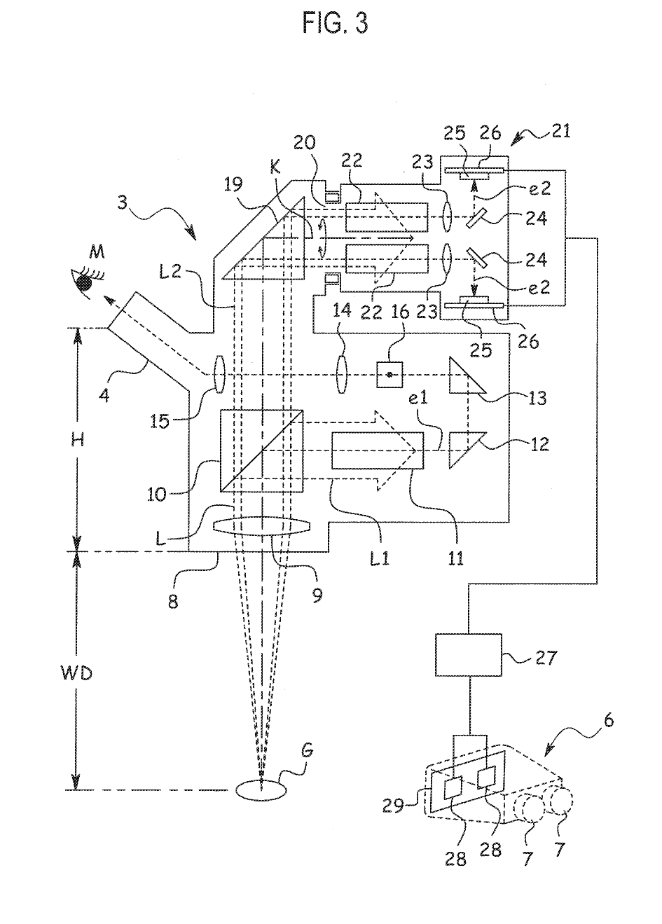

When the camera 21 is attached to the optical outlet 20 at the upper part of the surgical microscope 3, the second beam of light L2 is introduced into the camera 21. In this state, the camera 21 can be turned around an optical axis K of the second beam of light L2 as illustrated in FIG. 3.

Turning the camera 21 around the optical axis K results in turning the variable power optical systems 22 inside the camera 21. Then, only component beams e2 of the second beam of light L2 corresponding to the turned position pass through the variable power optical systems 22 to the imaging elements 25, respectively. The beams of light e2 reaching the imaging elements 25 are spaced apart from each other by a predetermined distance, and therefore, electronic images of the surgical field G provided by the imaging elements 25 have a predetermined binocular parallax.

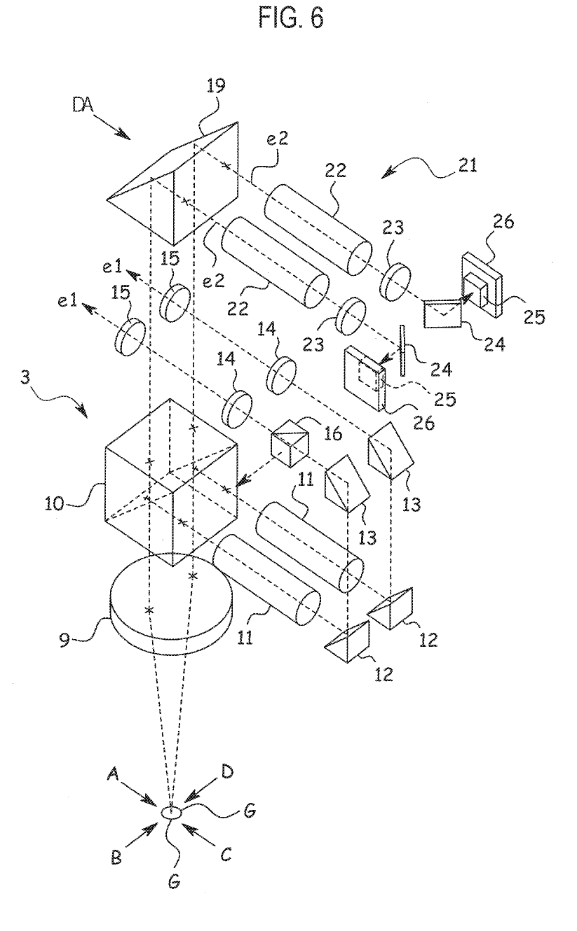

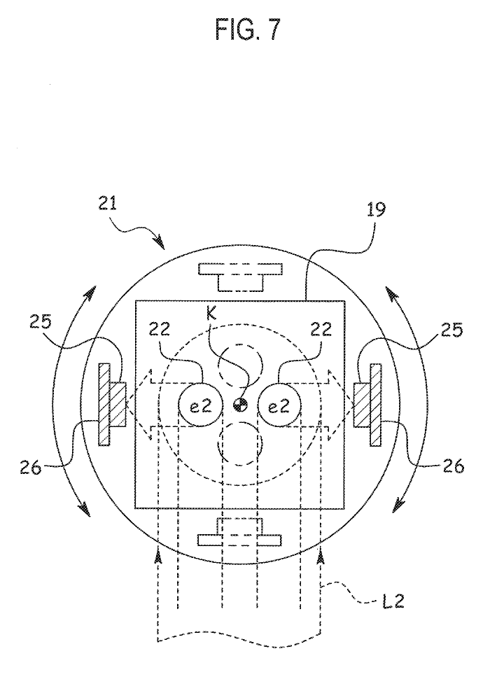

The camera 21 is able to be turned optionally, and therefore, is able to photograph the surgical field G in an optional direction. For example, the camera 21 may be turned to a position illustrated in FIG. 7, so that the pair of imaging elements 25 (hatched in FIG. 7) may provide a 3D image of the surgical field G seen in a direction A (FIG. 6). From this state, the camera 21 may be turned by 90 degrees each as illustrated in FIG. 5, to provide 3D images of the surgical field G viewed in directions B, C, and D, one at a time.

The electronic images acquired by the camera 21 are transmitted through a control unit 27 to the electronic image display unit, i.e., the 3D viewer 6. The 3D viewer 6 incorporates a left-and-right pair of display panels 28 that are organic EL displays assembled on a substrate 29. The substrate 29 receives signals from the control unit 27. Facing the display panels 28 are the left-and-right pair of eyepieces 7. The display panels 28 display the electronic images having binocular parallax, and therefore, the eyepieces 7 enable a stereoscopic observation.

The camera 21 is turned to an optional stereoscopic observation orientation to be viewed through the 3D viewer 6. Usually, a turning position of the camera 21 is adjusted according to a position where the 3D viewer 6 is located. If the assistant S is on the right side of the surgical microscope 3 and observes the 3D viewer 6 that is also on the right side of the surgical microscope 3, the camera 21 is turned so that the assistant S looks at the surgical field G from the right side (in the direction B). The 3D viewer 6 is set close to the surgical microscope 3, and therefore, the assistant S is able to extend his or her hands to assist the operation of the surgical field G conducted by the doctor M.

The working space WD between the lower end of the surgical microscope 3 and the surgical field G is wide according to the embodiment, and therefore, the doctor M is able to more freely conduct the operation with surgical tools and the assistant S is more easily extend his or her hands to help the doctor M.

The camera 21 is attached to the upper part of the surgical microscope 3, and therefore, a side face (right side face in FIG. 1) opposite to the side face to which the suspension arm 2 is connected is vacant. The vacant side face is provided with the accessory connection port 17 to which an accessory such as the fluorescent camera 18 is attachable.

In the above-mentioned embodiment, the electronic image display unit is the 3D viewer 6. Instead, the display unit may be a 3D monitor to be watched with polarizing glasses, or any other. The camera 21 may be turned manually or electrically around the optical axis K.

According to the first aspect of the present invention, the variable power optical systems in the surgical microscope are horizontally arranged to fold optical paths. This configuration reduces a vertical dimension of the surgical microscope between the eyepieces thereof and the lower end thereof, thereby expanding a working space under the surgical microscope. The camera is attached to an upper part of the surgical microscope, to free a side face of the surgical microscope and allow an accessory to be attached to the freed side face.

According to the second aspect of the present invention, the camera is attachable to and detachable from the surgical microscope. When not used, the camera can be detached from the surgical microscope to lighten the weight of the surgical microscope.

According to the third aspect of the present invention, the imaging elements in the camera are spaced apart from each other in opposite directions, and therefore, even imaging elements installed on large substrates are able to be incorporated in the camera without interference between them.

According to the fourth aspect of the present invention, the electronic image display unit is a 3D viewer having a pair of eyepieces, and therefore, an assistant is able to observe a surgical field with the 3D viewer at a position close to the surgical microscope and in a direction in which the assistant is oriented.

This patent application claims the benefit of priority under 35 U.S.C. 119(a) to Japanese Patent Application No. 2016-113204 filed on Jun. 7, 2016 whose disclosed contents are cited herein.

What is claimed is:

1. A surgical microscope system comprising:
a surgical microscope including:
a vertically-oriented objective optical system for passing a vertical beam of light traveling from a surgical field as an observation object and an optical branching unit for branching the vertical beam of light into a horizontal backward first beam of light and a vertical upward second beam of light;
paths of two beams of light derived from the first beam of light defined in such that the two beams path through a pair of horizontally-oriented variable power optical systems, reflected by a first reflectors in a frontward direction above the variable optical systems, and introduced into a left-and-right pair of eyepieces, wherein the surgical field is optically observed via the eyepieces; and
a second reflector reflecting the second beam of light in a horizontal direction, and an optical outlet arranged at an upper part of the surgical microscope and outputting the second beam of light;
a camera attached to the optical outlet and rotatable around an optical axis of the horizontal second beam of light, the camera including a pair of variable power optical systems and a pair of imaging elements, a pair of beams out of the horizontal second beam being picked up according to a rotation position of the camera to pass through the variable power optical systems to the imaging elements, respectively, and electronic images obtained by use of the imaging elements having binocular parallax and an orientation based on the rotation position of the camera; and
an electronic image display of the electronic images acquired by the camera.

2. The surgical microscope system of claim 1, wherein the camera is attachable to and detachable from the optical outlet.

3. The surgical microscope system of claim 1, wherein
the camera includes a reflector reflecting the picked-up beams by 90 degrees in opposite directions to each other, and
the imaging elements are arranged to face the oppositely reflected beams, respectively.

4. The surgical microscope system of claim 1, wherein
the electronic image display unit is a 3D viewer incorporating a left-and-right pair of display panels to display the electronic images acquired by the camera and a pair of eyepieces for observing the displayed images with eyes of an observer.
